(19) United States
(12) Patent Application Publication
(10) Pub. No.: US 2022/0320541 A1
(43) Pub. Date: Oct. 6, 2022

(54) FUEL CELL CONTROL METHOD, CONTROL SYSTEM AND ELECTRIC VEHICLE

(71) Applicant: Ceres Intellectual Property Company Limited, Horsham West Sussex (GB)

(72) Inventor: Lei Sun, Weifang, Shandong (CN)

(21) Appl. No.: 17/640,186

(22) PCT Filed: Oct. 15, 2020
(86) PCT No.: PCT/IB2020/059684

§ 371 Date: Mar. 3, 2022

(30) Foreign Application Priority Data
Sep. 4, 2019 (CN) 201910832103.7

(51) Int. Cl. H01M 8/04303; H01M 8/04746; H01M 8/04858

(52) U.S. Cl. CPC H01M 8/04303; H01M 8/04753; H01M 8/04902; H01M 2250/20

(57) ABSTRACT

A fuel cell control method, control system and electric vehicle. The control method comprises the following steps of determining that the fuel cell is shut down and controlling the fuel cell to enter a standby mode, wherein the standby mode comprises the step of controlling the electric quantity output by the stack module of the fuel cell such that it is used only for maintaining the working temperature of the fuel cell. From the above content, it can be known that according to the technical solution provided by the invention, the low-power consumption standby operation of the fuel cell can be maintained, the temperature of the fuel cell is ensured to be at the working temperature, the heat loss caused by the shutdown of the fuel cell is reduced, the power requirement of a whole vehicle is met in an instant response manner when the fuel cell is started for the second time, the starting time is short, the gas loss and the starting time caused by heating the fuel cell during the second starting are reduced, and the fuel cell does not need to be heated during the second starting, so that the rotating speed of a fan does not need to be increased, and the comfort of the electric vehicle is ensured.

### TECHNICAL FIELD

The present invention relates to the field of fuel cell control of fuel cell electric vehicles, particularly to a fuel cell control method, control system and electric vehicle.

### BACKGROUND ART

A fuel cell electric vehicle is a vehicle that uses the electricity generated by an on-board fuel cell as its power. The key to the fuel cell electric vehicle is the fuel cell.

When an existing fuel cell is started, the fuel cell needs to be heated to reach the working temperature, which lengthens the starting time. At the same time, heating the fuel cell requires more fuel gas, which affects the economic performance of the electric vehicle. Moreover, heating the fuel cell will increase the speed of the fan, increasing the noise and affecting the comfort of the electric vehicle.

### SUMMARY OF THE INVENTION

The present invention provides a fuel cell control method, a control system, and an electric vehicle to address the problems in the prior art.

A first aspect of the invention provides a fuel cell control method for a fuel cell electric vehicle, wherein the control method comprises: determining that the fuel cell is shut down; controlling the fuel cell to enter a standby mode, wherein the standby mode comprises the step of controlling the electric quantity output by the stack module of the fuel cell such that it is used only for maintaining the working temperature of the fuel cell; and controlling the fuel cell to be switched from the standby mode to a required power output mode to raise the starting speed when the fuel cell is restarted from shutdown.

Optionally, the step of determining that the fuel cell is shut down comprises: judging that the fuel cell electric vehicle does not have an extended range power demand for the fuel cell to determine that the fuel cell is shut down.

Optionally, the step of controlling the electric quantity output by the stack module of the fuel cell such that it is used only for maintaining the working temperature of the fuel cell comprises: controlling the flow, pressure and temperature of the air, fuel gas and water entering the stack module of the fuel cell as well as the output current of the stack module to ensure that the electric quantity output by the stack module of the fuel cell is used only for maintaining the working temperature of the fuel cell and not for charging the power battery.

A second aspect of the present invention provides a fuel cell control system for a fuel cell electric vehicle, wherein the control system comprises a vehicle control unit, a fuel cell control unit, and a fuel cell. The vehicle control unit is used for determining that the fuel cell is shut down and controlling the fuel cell to enter a standby mode, wherein the standby mode comprises the step of controlling through the fuel cell control unit that the electric quantity output by the stack module of the fuel cell is used only for maintaining the working temperature of the fuel cell. The vehicle control unit controls the fuel cell to be switched from the standby mode to a required power output mode to raise the starting speed when the fuel cell is restarted from shutdown.

Optionally, the vehicle control unit determines that the fuel cell is shut down, when the vehicle control unit judges that the fuel cell electric vehicle does not have an extended range power demand for the fuel cell to determine that the fuel cell is shut down.

Optionally, the step of controlling through the fuel cell control unit that the electric quantity output by the stack module of the fuel cell is used only for maintaining the working temperature of the fuel cell comprises: the vehicle control unit controls the fuel cell to enter a standby mode and sends a standby instruction to the fuel cell control unit; and according to the standby instruction, the fuel cell control unit controls the electric quantity output by the stack module of the fuel cell such that it is used only for maintaining the working temperature of the fuel cell.

Optionally, the control system comprises an air control unit, a fuel gas control unit, a water control unit and a stack module pre-charge unit. The air control unit is used for providing air for the stack module of the fuel cell and controlling the flow, pressure, and temperature of the air. The fuel gas control unit is used for providing fuel gas for the stack module of the fuel cell and controlling the flow, pressure, and temperature of the fuel gas. The water control unit is used for providing water for the stack module of the fuel cell and controlling the flow, pressure, and temperature of the water. The stack pre-charge unit is used for pre-charging the current output by the stack module and outputting the current to a DC voltage converter after completion of the pre-charging process.

Here, the fuel cell control unit controls the electric quantity output by the stack module of the fuel cell such that it is used only for maintaining the working temperature of the fuel cell. The fuel cell control unit is used for controlling the air control unit to provide the flow, pressure and temperature of the air for the stack module of the fuel cell, controlling the fuel gas control unit to provide the flow, pressure and temperature of the fuel gas for the stack module of the fuel cell, controlling the water control unit to provide the flow, pressure and temperature of the water for the stack module of the fuel cell and controlling the current output by the stack pre-charge unit to the DC voltage converter to ensure that the electric quantity output by the stack module of the fuel cell is used only for maintaining the working temperature of the fuel cell and not for charging the power battery.

A third aspect of the present invention further provides a fuel cell electric vehicle, which comprises the control system according to the second aspect.

The present invention provides a fuel cell control method, control system and electric vehicle. The control method comprises determining that the fuel cell is shut down and controlling the fuel cell to enter a standby mode, wherein the standby mode comprises the step of controlling the electric quantity output by the stack module of the fuel cell such that it is used only for maintaining the working temperature of the fuel cell. From the above content, it can be seen that when it is determined that the fuel cell is shut down, by controlling the electric quantity output by the stack module of the fuel cell such that it is used only for maintaining the working temperature of the fuel cell, the output power of the stack module only meets its own loss. By maintaining the low-power consumption standby operation of the fuel cell, it is ensured that the fuel cell is at the working temperature, the heat loss caused by the shutdown of the fuel cell is reduced, the power requirement of a whole vehicle is met in an instant response manner when the fuel cell is started for the second time, the starting time is short, the gas loss and the starting time caused by heating the fuel cell during the second starting are reduced, and the fuel cell does not need to be heated during the second starting, so that the rotation speed of a fan does not need to be increased, and the comfort of the electric vehicle is ensured.

### BRIEF DESCRIPTION OF THE DRAWINGS

The drawings used in the description of the embodiments will be briefly described below. The drawings in the description below are merely embodiments of the present invention.

FIG. 1 is a flow chart of a fuel cell control method.

FIG. 2 is a flow chart of an alternative fuel cell control method.

FIG. 3 is a structural diagram of a fuel cell control system.

### DETAILED DESCRIPTION

Embodiments of the present invention will be described below in conjunction with the drawings. The described embodiments are only some, not all of the embodiments of the present invention.

When an existing fuel cell is started, the fuel cell needs to be heated to reach the working temperature, which lengthens the starting time. At the same time, heating the fuel cell requires more fuel gas, which affects the economic performance of the electric vehicle. Moreover, heating the fuel cell will increase the speed of the fan, increasing the noise and affecting the comfort of the electric vehicle.

The working temperature of the fuel cell is relatively high, and the temperature must reach 600° C. before it can work. Therefore, the fuel cell needs to be heated when the fuel cell is started, that is, the fuel gas injected into the burner is burned to heat the air and fuel gas entering the stack module of the fuel cell to achieve the purpose of heating the fuel cell, so that the fuel cell reaches the working temperature.

The present invention provides a fuel cell control method, a control system, and an electric vehicle, wherein the control method comprises the following steps of: determining that the fuel cell is shut down and controlling the fuel cell to enter a standby mode, wherein the standby mode comprises the step of controlling the electric quantity output by the stack module of the fuel cell such that it is used only for maintaining the working temperature of the fuel cell. When it is determined that the fuel cell is shut down, by controlling the electric quantity output by the stack module of the fuel cell such that it is used only for maintaining the working temperature of the fuel cell, the output power of the stack module only meets its own loss. By maintaining the low-power consumption standby operation of the fuel cell, it is ensured that the fuel cell is at the working temperature, the heat loss caused by the shutdown of the fuel cell is reduced, the power requirement of a whole vehicle is met in an instant response manner when the fuel cell is started for the second time, the starting time is short, the gas loss and the starting time caused by heating the fuel cell during the second starting are reduced, and the fuel cell does not need to be heated during the second starting, so that the rotating speed of a fan does not need to be increased, and the comfort of the electric vehicle is ensured.

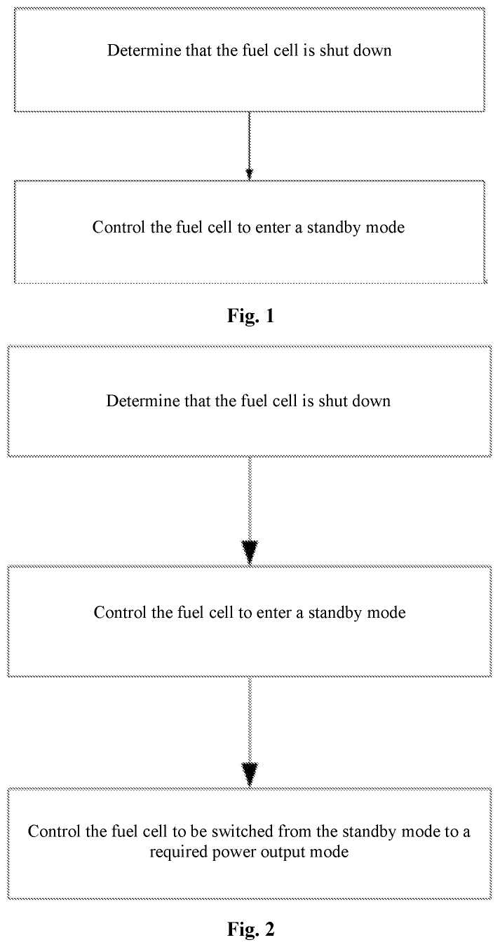

FIG. 1 is a flow chart of a fuel cell control method provided by an embodiment of the present invention. The control method comprises the following steps of: determining that the fuel cell is shut down; and controlling the fuel cell to enter a standby mode, wherein the standby mode comprises the step of controlling the electric quantity output by the stack module of the fuel cell such that it is used only for maintaining the working temperature of the fuel cell.

The stack module of the fuel cell may comprise stacks composed of cells, reformers, heat exchangers, burners, steam generators, and other components, and generates the required electrical power through electrochemical reactions. In other words, the fuel cell works by inputting air, fuel gas and water to generate power and provides the power to a power battery and high-voltage components.

The stack module of the fuel cell comprises air intake and exhaust ports, fuel gas intake and exhaust ports, and power anode and cathode output ports. The cathode of the stack module is fed with air and the anode is fed with fuel gas. At a certain temperature, an electrochemical reaction occurs through the cells in the stack module. The oxygen at the cathode becomes cations, which are transferred to the anode through the electrolyte and react with the hydrogen ions and CO at the anode to produce water and CO₂. Electrons form an electrical circuit between the anode and cathode of the sub-stack through loads.

When it is determined that the fuel cell is shut down, by controlling the electric quantity output by the stack module of the fuel cell such that it is used only for maintaining the working temperature of the fuel cell and not for charging the power battery, not only can the fuel cell be in a low power consumption state as the electric quantity output by the stack module of the fuel cell is used only for maintaining the working temperature of the fuel cell, but also the temperature of the fuel cell can be maintained at the working temperature during shutdown, so that the fuel cell does not need to be heated to reach the working temperature during restart, which will increase consumption of fuel gas and starting time.

In an embodiment of the present invention, the step of determining that the fuel cell is shut down comprises the step of judging that the fuel cell electric vehicle does not have an extended range power demand for the fuel cell to determine that the fuel cell is shut down.

When the fuel cell electric vehicle does not have an extended range power demand for the fuel cell, it means that there is no need to charge the power battery through the fuel cell and the fuel cell is in a shutdown state.

In an embodiment of the present invention, the step of controlling the electric quantity output by the stack module of the fuel cell such that it is used only for maintaining the working temperature of the fuel cell comprises the step of controlling the flow, pressure and temperature of the air, fuel gas and water entering the stack module of the fuel cell as well as the output current of the stack module to ensure that the electric quantity output by the stack module of the fuel cell is used only for maintaining the working temperature of the fuel cell and not for charging the power battery.

Before the fuel cell is started, the control parameters corresponding to the output power of the stack, including the output current and output voltage corresponding to each output power, will be stored in advance. When the fuel cell is running, parameters such as the flow, pressure and temperature of air, fuel gas, and water are dynamically adjusted according to the output power of the stack, the volt-ampere characteristic curve of the stack and the electrochemical reaction model of the stack, so that the output current and output voltage match the corresponding output power.

After the fuel cell is controlled to enter a standby mode, the output power of the stack needed to maintain the working temperature only is calculated and the parameters such as the flow, pressure and temperature of air, fuel gas and water are dynamically adjusted according to the output power, the volt-ampere characteristic curve of the stack and the electrochemical reaction model of the stack, so that the output current and output voltage match the output power.

When it is determined that the fuel cell enters a standby mode, by controlling the flow, pressure and temperature of the air, fuel gas, and water entering the stack module and the current output by the stack module, the electric quantity output by the stack module is controlled, thereby ensuring that the electric quantity output by the stack module is used only for maintaining the working temperature of the fuel cell and not for charging the power battery so that the fuel cell is in a low power consumption state and the fuel consumption of the fuel cell is in as low a state as possible.

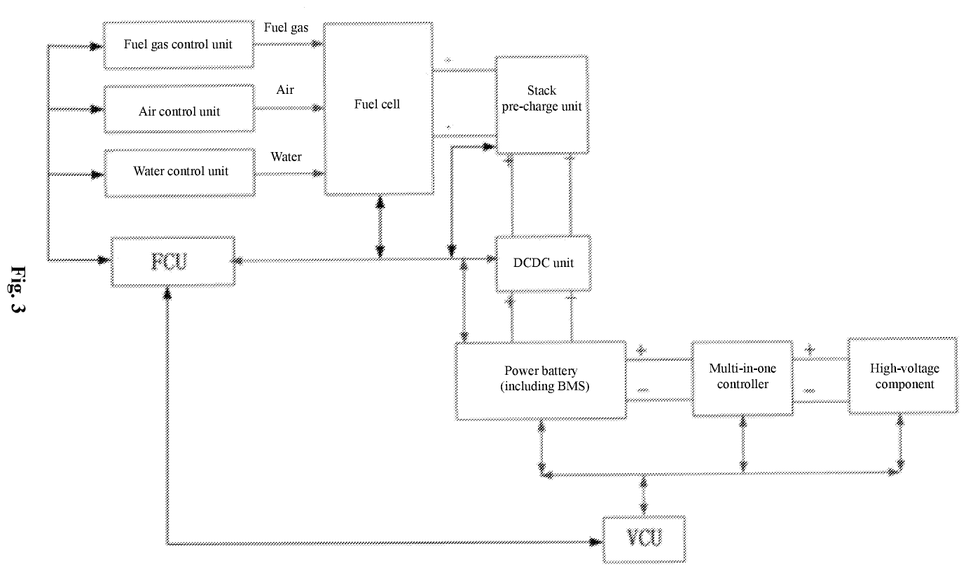

As shown in FIG. 2, in an embodiment of the present application, the fuel cell is controlled to be switched from the standby mode to a required power output mode to raise the starting speed when the fuel cell is restarted from shutdown.

The fuel cell is controlled to be switched from the standby mode to a required power output mode and in this process, because the temperature of the fuel cell in a standby mode has been maintained at the working temperature at all times, there is no need to heat the fuel cell to bring it to the working temperature in the process of switching to the required power output mode, thereby saving the switching time and raising the starting speed.

As shown in FIG. 3, an embodiment of the present application provides a fuel cell control system for a fuel cell electric vehicle, wherein the control system comprises a vehicle control unit (VCU), a fuel cell control unit (FCU) and a fuel cell. The vehicle control unit is used for determining that the fuel cell is shut down and controlling the fuel cell to enter a standby mode, wherein the standby mode comprises the step of controlling through the fuel cell control unit that the electric quantity output by the stack module of the fuel cell is used only for maintaining the working temperature of the fuel cell.

The vehicle control unit is also used to control the power output of the vehicle and the interaction with the fuel cell control unit and control the stack module in different working states.

The stack module of the fuel cell may comprise stacks composed of cells, reformers, heat exchangers, burners, steam generators, and other components, and generates the required electrical power through electrochemical reactions. In other words, the fuel cell works by inputting air, fuel gas, and water to generate power and provides the power to a power battery and high-voltage components.

The stack module of the fuel cell comprises air intake and exhaust ports, fuel gas intake and exhaust ports, and power anode and cathode output ports. The cathode of the stack module is fed with air and the anode is fed with fuel gas. At a certain temperature, an electrochemical reaction occurs through the cells in the stack module. The oxygen at the cathode becomes cations, which are transferred to the anode through the electrolyte and react with the hydrogen ions and CO at the anode to produce water and CO₂. Electrons form an electrical circuit between the anode and cathode of the sub-stack through loads.

In this embodiment, when it is determined that the fuel cell is shut down, by controlling through the fuel cell control unit that the electric quantity output by the stack module of the fuel cell is used only for maintaining the working temperature of the fuel cell, the vehicle control unit can not only put the fuel cell in a low power consumption state by causing the electric quantity output by the stack module of the fuel cell to be used only for maintaining the working temperature of the fuel cell but also maintain the temperature of the fuel cell at the working temperature during shutdown, so that the fuel cell does not need to be heated to reach the working temperature during restart, which will increase consumption of fuel gas and starting time.

In an embodiment of the present invention, the vehicle control unit determines that the fuel cell is shut down. The vehicle control unit judges that the fuel cell electric vehicle does not have an extended range power demand for the fuel cell to determine that the fuel cell is shut down.

When the fuel cell electric vehicle does not have an extended range power demand for the fuel cell, it means that there is no need to charge the power battery through the fuel cell and the fuel cell is in a shutdown state.

In an embodiment of the present invention, the step of controlling through the fuel cell control unit that the electric quantity output by the stack module of the fuel cell is used only for maintaining the working temperature of the fuel cell comprises steps that the vehicle control unit controls the fuel cell to enter a standby mode and sends a standby instruction to the fuel cell control unit; and according to the standby instruction, the fuel cell control unit controls the electric quantity output by the stack module of the fuel cell such that it is used only for maintaining the working temperature of the fuel cell.

As shown in FIG. 3, in an embodiment of the present invention, the control system comprises an air control unit, a fuel gas control unit, a water control unit and a stack module pre-charge unit. The air control unit is used for providing air for the stack module of the fuel cell and controlling the flow, pressure, and temperature of the air. The fuel gas control unit is used for providing fuel gas for the stack module of the fuel cell and controlling the flow, pressure, and temperature of the fuel gas. The water control unit is used for providing water for the stack module of the fuel cell and controlling the flow, pressure, and temperature of the water. The stack pre-charge unit is used for pre-charging the current output by the stack module and outputting the current to a DC voltage converter (DCDC unit) after completion of the pre-charging process.

Here, the fuel cell control unit controls the electric quantity output by the stack module of the fuel cell such that it is used only for maintaining the working temperature of the fuel cell. The fuel cell control unit is used for controlling the air control unit to provide the flow, pressure and temperature of the air for the stack module of the fuel cell, controlling the fuel gas control unit to provide the flow, pressure and temperature of the fuel gas for the stack module of the fuel cell, controlling the water control unit to provide the flow, pressure and temperature of the water for the stack module of the fuel cell and controlling the current output by the stack pre-charge unit to the DCDC unit to ensure that the electric quantity output by the stack module of the fuel cell is used only for maintaining the working temperature of the fuel cell and not for charging the power battery. Here, the water is deionized water.

The fuel cell control unit controls the air control unit, the fuel gas control unit, and the water control unit to input air, fuel gas, and water to the stack module for working and generating power, controls the stack module to pre-charge the generated power through the stack pre-charge unit, outputs the power to the DCDC unit after completion of the pre-charging process, and controls whether to charge the power battery or not by controlling the current output by the stack pre-charge unit to the DCDC unit, or controls whether to charge the power battery or not by controlling the output voltage of the DCDC unit.

The fuel cell control unit is further used to control the pre-charging process of the stack pre-charge unit, communicate with the DCDC unit and control the current output by the stack pre-charge unit to the DCDC unit, i.e., control the input current of the DCDC unit, or is used to control the output voltage of the DCDC unit.

Before the fuel cell is started, the control parameters corresponding to the output power of the stack, including the output current and output voltage corresponding to each output power, will be stored in advance. When the fuel cell is running, the parameters such as the flow, pressure and temperature of air, fuel gas, and water are dynamically adjusted according to the output power of the stack, the volt-ampere characteristic curve of the stack, and the electrochemical reaction model of the stack, so that the output current and output voltage match the corresponding output power.

After the fuel cell is controlled to enter a standby mode, the output power of the stack needed to maintain the working temperature only is calculated and the parameters such as the flow, pressure and temperature of air, fuel gas, and water are dynamically adjusted according to the output power, the volt-ampere characteristic curve of the stack and the electrochemical reaction model of the stack, so that the output current and output voltage match the output power.

The fuel cell control unit controls the output current of the stack module by controlling the current output by the stack pre-charge unit to the DCDC unit.

When it is determined that the fuel cell enters a standby mode, by controlling the flow, pressure and temperature of the air, fuel gas, and water entering the stack module as well as the current output by the stack module, the vehicle control unit controls the electric quantity output by the stack module, thereby ensuring that the electric quantity output by the stack module is used only for maintaining the working temperature of the fuel cell and not for charging the power battery so that the fuel cell is in a low power consumption state and the fuel consumption of the fuel cell is in as low a state as possible.

In an embodiment of the present invention, the vehicle control unit controls the fuel cell to be switched from the standby mode to a required power output mode to raise the starting speed when the fuel cell is restarted from shutdown.

When the fuel cell is restarted from shutdown, the vehicle control unit controls the fuel cell to be switched from standby mode to a required power output mode and in this process, because the temperature of the fuel cell in standby mode has been maintained at the working temperature at all times, there is no need to heat the fuel cell to bring it to working temperature in the process of switching to the required power output mode, thereby saving the switching time and raising the starting speed.

As shown in FIG. 3, in an embodiment of the present invention, the control system comprises a power battery, which comprises a battery management system (BMS), a multi-in-one controller and high-voltage components.

The power battery is connected to the stack module in parallel on a DC bus and is used to provide a power supply required to instantaneously power an electric vehicle. To be specific, the fuel cell control unit controls the pre-charge unit to complete a pre-charging process, causes the power output port of the stack module to be connected to the DCDC unit and charges the power battery by controlling the input current of the DCDC unit; the battery management system sends the maximum charge and discharge power output parameters of the power battery to the vehicle control unit, and the vehicle control unit provides power for the high-voltage components of the vehicle according to these parameters and in combination with the maximum output power of the stack module presently sent by the fuel cell control unit.

The multi-in-one controller is used to distribute power of the DC bus and comprises a power distribution unit (PDU), a low-voltage output DC voltage converter, an electric steering pump controller and an electric air compressor controller.

The high-voltage components include a motor controller, an electric steering pump, an electric air compressor, an electric air conditioner, an electric defroster, an electric heater and an air blower controller.

An embodiment of the present invention provides a fuel cell electric vehicle, comprising the control system in any of the above embodiments.

The present invention provides a fuel cell control method, a control system, and an electric vehicle. The control method comprises the following steps of: determining that the fuel cell is shut down and controlling the fuel cell to enter a standby mode, wherein the standby mode comprises the step of controlling the electric quantity output by the stack module of the fuel cell such that it is used only for maintaining the working temperature of the fuel cell. When it is determined that the fuel cell is shut down, by controlling the electric quantity output by the stack module of the fuel cell such that it is used only for maintaining the working temperature of the fuel cell, the output power of the stack module only meets its own loss; and by maintaining the low-power consumption standby operation of the fuel cell, it is ensured that the fuel cell is at the working temperature, the heat loss caused by the shutdown of the fuel cell is reduced, the power requirement of a whole vehicle is met in an instant response manner when the fuel cell is started for the second time, the starting time is short, the gas loss and the starting time caused by heating the fuel cell during the second starting are reduced, and the fuel cell does not need to be heated during the second starting, so that the rotating speed of a fan does not need to be increased, and the comfort of the electric vehicle is ensured.

Various modifications to these embodiments will be apparent. The general principle defined herein can be implemented in other embodiments without departing from the scope of the present invention.

1. A fuel cell control method for a fuel cell electric vehicle, the method comprising:
determining that a fuel cell is shut down;
controlling the fuel cell to enter a standby mode, wherein the standby mode comprises controlling the electric output of a stack module of the fuel cell such that it is used only for maintaining the working temperature of the fuel cell; and
controlling the fuel cell to be switched from the standby mode to a required power output mode to raise the starting speed when the fuel cell is restarted from shutdown.

2. The control method according to claim 1, wherein the step of determining that the fuel cell is shut down comprises:
determining that the fuel cell electric vehicle does not have an extended range power demand for the fuel cell to determine that the fuel cell is shut down.

3. The control method according to claim 1, wherein the step of controlling the electric output of the stack module comprises:
controlling the flow, pressure, and temperature of the air, fuel gas, and water entering the stack module of the fuel cell as well as the output current of the stack module to ensure that the electric output of the stack module is used only for maintaining the working temperature of the fuel cell and not for charging the power battery.

4. A fuel cell control system for a fuel cell electric vehicle, comprising:
a vehicle control unit,
a fuel cell control unit, and
a fuel cell;
wherein
the vehicle control unit determines that the fuel cell is shut down and controls the fuel cell to enter a standby mode, wherein the standby mode comprises controlling through the fuel cell control unit that the electric output of a stack module is used only for maintaining the working temperature of the fuel cell; and
the vehicle control unit controls the fuel cell to be switched from the standby mode to a required power output mode to raise the starting speed when the fuel cell is restarted from shutdown.

5. The control system according to claim 4, wherein the vehicle control unit is configured to determine that the fuel cell is shut down, wherein:
the vehicle control unit is configured to determine that the fuel cell electric vehicle does not have an extended range power demand for the fuel cell to determine that the fuel cell is shut down.

6. The control system according to claim 4, wherein:
the vehicle control unit is configured to control the fuel cell to enter a standby mode and send a standby instruction to the fuel cell control unit; and
according to the standby instruction, the fuel cell control unit is configured to control the electric output of the stack module of the fuel cell so that it is used only for maintaining the working temperature of the fuel cell.

7. The control system according to claim 4, wherein the control system comprises an air control unit, a fuel gas control unit, a water control unit, and a stack module pre-charge unit;
the air control unit is configured to provide air for the stack module of the fuel cell and control the flow, pressure and temperature of the air;
the fuel gas control unit is configured to provide fuel gas for the stack module of the fuel cell and control the flow, pressure, and temperature of the fuel gas;
the water control unit is configured to provide water for the stack module of the fuel cell and control the flow, pressure, and temperature of the water; and
the stack pre-charge unit is configured to pre-charge the current output by the stack module and output the current to a DC voltage converter after completion of the pre-charging process;
wherein, the fuel cell control unit is configured to control the electric output of the stack module of the fuel cell to be used only for maintaining the working temperature of the fuel cell, and
the fuel cell control unit is configured to control the air control unit to provide the flow, pressure, and temperature of the air for the stack module of the fuel cell, control the fuel gas control unit to provide the flow, pressure, and temperature of the fuel gas for the stack module of the fuel cell, control the water control unit to provide the flow, pressure, and temperature of the water for the stack module of the fuel cell, and control the current output by the stack pre-charge unit to the DC voltage converter to ensure that the electric quantity output by the stack module of the fuel cell is used only for maintaining the working temperature of the fuel cell and not for charging the power battery.

8. A fuel cell electric vehicle, wherein the fuel cell electric vehicle comprises the control system of claim 4.
